(19) United States
(12) Patent Application Publication
(10) Pub. No.: US 2016/0297145 A1
(43) Pub. Date: Oct. 13, 2016

(54) FORMING APPARATUS AND FORMING METHOD OF MOLDED ARTICLE

(71) Applicant: FUJI XEROX CO., LTD., Tokyo (JP)

(72) Inventor: Torahiko KANDA, Kanagawa (JP)

(73) Assignee: FUJI XEROX CO., LTD., Tokyo (JP)

(21) Appl. No.: 14/875,748

(22) Filed: Oct. 6, 2015

(30) Foreign Application Priority Data
Apr. 7, 2015 (JP) 2015-078613

(51) Int. Cl. B29C 67/00

(52) U.S. Cl. CPC B29C 67/0088; B29C 67/0059; B29K 2101/12

(57) ABSTRACT

Provided is a forming apparatus including a base plate, a moving unit that reciprocates relatively to the base plate, an ejection section that includes plural ejection units and that ejects a first droplet and then ejects a second droplet between the first droplets, a first irradiation unit that irradiates the first droplet with light so that the first droplet is cured before the second droplet is ejected, a pair of second irradiation units that are provided in the moving unit with interposing the plural ejection units in the movement direction and irradiates the first droplet and the second droplet with light so that the first droplet and the second droplet are cured, and a control unit that controls the moving unit, the ejection unit, and the second irradiation unit to form a three-dimensional object through stacking layers formed by the cured first and second droplets.

### CROSS-REFERENCE TO RELATED APPLICATIONS

This application is based on and claims priority under 35 USC 119 from Japanese Patent Application No. 2015-078613 filed Apr. 7, 2015.

### BACKGROUND

### Technical Field

The present invention relates to a forming apparatus and a forming method of a molded article.

### SUMMARY

According to an aspect of the invention, there is provided a forming apparatus including:
a base plate;
a moving unit that reciprocates relatively to the base plate;
an ejection section that includes plural ejection units provided in the moving unit apart from the base plate in a movement direction of the moving unit and that ejects a first droplet toward the base plate from an ejection unit on a downstream side in the movement direction while moving relatively to the base plate and then ejects a second droplet between the first droplets from an ejection unit on an upstream side;
a first irradiation unit that is provided between the plural ejection units in the moving unit and irradiates the first droplet with light so that the first droplet is cured before the second droplet is ejected;
a pair of second irradiation units that are provided in the moving unit with interposing the plural ejection units in the movement direction and irradiates the first droplet and the second droplet with light so that the first droplet and the second droplet are cured; and
a control unit that controls the moving unit, the ejection unit, and the second irradiation unit while moving the moving unit relatively to the base plate to form a three-dimensional object through stacking layers formed by the cured first and second droplets.

### BRIEF DESCRIPTION OF THE DRAWINGS

Exemplary embodiments of the present invention will be described in detail based on the following figures, wherein:

FIG. 1 is a diagram (front view) schematically showing a state in which a three-dimensional object is formed by a forming apparatus of a first exemplary embodiment;

FIG. 2 is a diagram (top view) schematically showing the forming apparatus of the first exemplary embodiment;

FIG. 3 is a timing chart of elements when a layer is formed while a carriage of the forming apparatus of the first exemplary embodiment is caused to reciprocate;

FIG. 4 is a diagram showing a state in which a layer is formed while a carriage of the forming apparatus of the first exemplary embodiment is caused to reciprocate and schematically showing a process of forming two layers through stacking another layer on the layer;

FIG. 5 is a diagram showing a state in which a layer is formed while the carriage of the forming apparatus of the first exemplary embodiment is caused to reciprocate and schematically showing how many times a droplet to form the first layer is irradiated with light in a period of reciprocating of the carriage;

FIG. 6 is a diagram showing a state in which a layer is formed while the carriage of the forming apparatus of the first exemplary embodiment is caused to reciprocate and schematically showing an amount of light with which a droplet to form the first layer is irradiated in a period of reciprocation of the carriage;

FIG. 7 is a diagram (front view) schematically showing a state in which a forming apparatus of a first comparative exemplary embodiment forms a three-dimensional object;

FIG. 8 is a diagram showing a state in which a layer is formed while a carriage of the forming apparatus of the first comparative exemplary embodiment is caused to reciprocate and schematically showing a process in which the reciprocation of the carriage in a movement direction causes one layer to be formed;

FIG. 9 is a diagram showing a state in which a layer is formed while a carriage of a forming apparatus of a second exemplary embodiment is caused to reciprocate and schematically showing an amount of light with which a droplet to form the first layer is irradiated in a period of reciprocation of the carriage;

FIG. 10 is a timing chart of elements when a layer is formed while a carriage of a forming apparatus of a third exemplary embodiment is caused to reciprocate;

FIG. 11 is a diagram showing a state in which a layer is formed while the carriage of the forming apparatus of the third exemplary embodiment is caused to reciprocate and schematically showing how many times a droplet to form the first layer is irradiated with light in a period of reciprocation of the carriage;

FIG. 12 is a diagram showing a state in which a layer is formed while the carriage of the forming apparatus of the third exemplary embodiment is caused to reciprocate and schematically showing an amount of light with which a droplet to form the first layer is irradiated in a period of reciprocation of the carriage;

FIG. 13 is a timing chart of elements when a layer is formed while a carriage of a forming apparatus of a fourth exemplary embodiment is caused to reciprocate;

FIG. 14 a diagram showing a state in which a layer is formed while the carriage of the forming apparatus of the fourth exemplary embodiment is caused to reciprocate and schematically showing how many times a droplet to form the first layer is irradiated with light in a period of reciprocation of the carriage;

FIG. 15 is a diagram showing a state in which a layer is formed while the carriage of the forming apparatus of the fourth exemplary embodiment is caused to reciprocate and schematically showing an amount of light with which a droplet to form the first layer is irradiated in a period of reciprocation of the carriage;

FIG. 16 is a diagram showing a state in which a layer is formed while a carriage of a forming apparatus of a fifth exemplary embodiment is caused to reciprocate and schematically showing an amount of light with which a droplet to form the first layer is irradiated in a period of reciprocation of the carriage;

FIGS. 17A and 17B are diagrams showing a forming apparatus of a modification example of the exemplary embodiment and, as diagrams (front views), schematically showing an arrangement relationship between an ejection section and an irradiation unit;

FIG. 18 is a diagram (front view) schematically showing a forming apparatus of another modification example of the exemplary embodiment;

FIG. 19 is a diagram (front view) schematically showing a forming apparatus of still another modification example of the exemplary embodiment; and

FIG. 20 is a diagram (front view) schematically showing a forming apparatus of still another modification example of the exemplary embodiment.

### DETAILED DESCRIPTION

### Outline

Hereinafter, exemplary embodiments will be described as five exemplary embodiments (hereinafter, first to fifth exemplary embodiments), respectively. In the following description, a ±Z direction in the drawings indicates an apparatus height direction (a Z direction and a −Z direction indicate an upward side and a downward side, respectively), a ±X direction indicates an apparatus width direction (an X direction and a −X direction indicate one end side and the other end side, respectively), and a direction (±Y direction) intersecting with the ±Z direction and the ±X direction indicates an apparatus depth direction (a Y direction and a −Y direction indicate a backward direction and a frontward direction, respectively).

### First Exemplary Embodiment

Hereinafter, a forming apparatus 10 of the first exemplary embodiment will be described with reference to the drawings. First, a configuration of the forming apparatus 10 of the present exemplary embodiment will be described. Subsequently, a forming method of a molded article Musing the forming apparatus 10 of the present exemplary embodiment will be described. Subsequently, the effects of the present exemplary embodiment will be described.

### Configuration

The forming apparatus 10 of the present exemplary embodiment has a function of ejecting a first droplet D1 and a second droplet D2 to be described below toward a base plate BD and of forming a three-dimensional object VM through stacking layers LR formed by curing the first droplet D1 and the second droplet D2. The first droplet D1 and the second droplet D2 will be described below in a technical viewpoint and, in the following description, in a case where there is no need to distinguish the first droplet D1 from the second droplet D2, both the first droplet D1 and the second droplet D2 will be described as a droplet D.

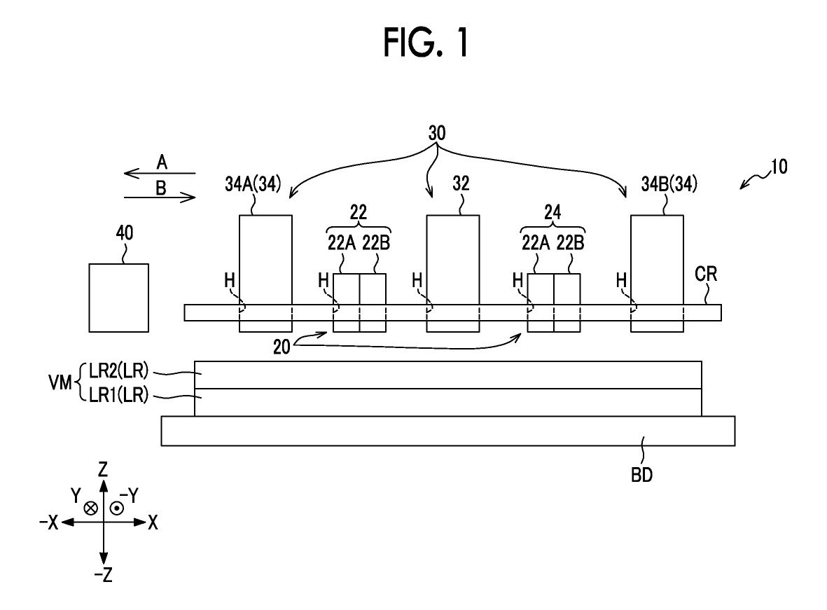

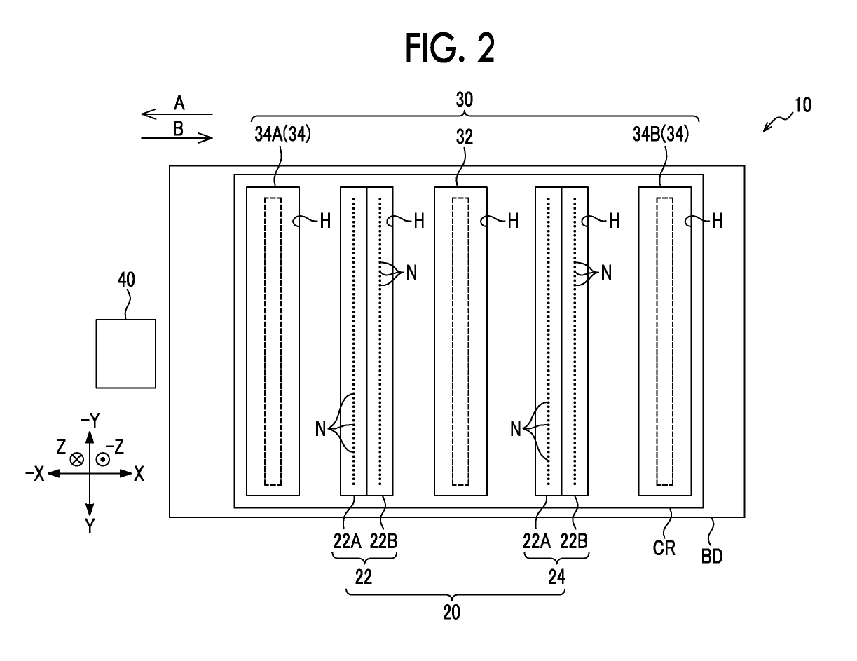

As shown in FIG. 1 and FIG. 2, the forming apparatus 10 is configured to include the base plate BD, a carriage CR, an ejection section 20, an irradiation unit 30, and a control unit 40.

### Base Plate

As shown in FIG. 1 and FIG. 2, the base plate BD is formed of a plate having a top surface formed in the apparatus width direction and in the apparatus depth direction. The three-dimensional object VM is formed on the top surface of the base plate BD.

### Carriage

The carriage CR has a function of reciprocating relatively to the base plate BD. Here, the carriage CR is an example of a moving unit. As shown in FIG. 1 and FIG. 2, the carriage CR is formed of a rectangular frame and is disposed along the top surface of the base plate BD. In addition, five long through-holes H are formed at five places in the apparatus depth direction. The long through-holes H are disposed at predetermined intervals from one end to the other end in the apparatus width direction. A first ejection unit 22 and a second ejection unit 24 which configure the ejection section 20 to be described below, and a first irradiation unit 32 and second irradiation units 34A and 34B which configure the irradiation unit 30 to be described below, are fit in and fixed to the five through-holes H of the carriage CR. In other words, the ejection section 20 and the irradiation unit 30 are provided in the carriage CR. Thus, when the carriage CR reciprocates relatively to the base plate BD, the ejection section 20 and the irradiation unit 30 are configured to reciprocate relatively to the base plate BD.

The carriage CR is configured to be driven by a drive source (not illustrated), to move along plural guide rails (not illustrated), and to be able to reciprocate within a predetermined range in the apparatus width direction. Here, the apparatus width direction is an example of a movement direction. In addition, the carriage CR is configured to reciprocate within a predetermined range in the apparatus height direction.

In addition, the carriage CR is configured to be disposed at a home position by the drive source of the carriage CR, which is controlled by the control unit 40, in a period in which the forming apparatus 10 does not perform a forming operation, that is, in a period from after an end of the forming operation to a start of the forming operation. Here, the home position means a position of an end on one end side in the apparatus width direction and of an end on the lower side in the apparatus height direction in the forming apparatus 10. In a state in which the carriage CR is disposed at the home position, the ejection section 20 and the irradiation unit 30 provided in the carriage CR are spaced apart from the top surface of the base plate BD.

### Ejection Unit

As shown in FIG. 1 and FIG. 2, the ejection section 20 includes the first ejection unit 22 and the second ejection unit 24. The ejection section 20, which is controlled by the control unit 40 to be described below, reciprocates along with the carriage CR with respect to the base plate BD and has a function of causing the first ejection unit 22 to eject a droplet D and of causing the second ejection unit 24 to eject a droplet D. Here, the first ejection unit 22 and the second ejection unit 24 are examples of plural ejection sections. First ejection section

The first ejection unit 22 includes a first head 22A and a second head 22B. The first head 22A has a function of ejecting a droplet D formed of a model material. In addition, the second head 22B has a function of ejecting a droplet D formed of a support material. The model material and the support material of the present exemplary embodiment are configured to contain a light curing resin (in the present exemplary embodiment, an ultraviolet curing resin as an example). When the droplet D configured of the model material and the support material of the present exemplary embodiment is irradiated with an amount of light (or illumination intensity corresponding to the amount of light) of, for example, 6 mJ/cm², the droplet D is cured to the extent that the droplet D does not move from a landing position even when the droplet D contacts with a droplet D which is not irradiated with light. The droplet D configured of the model material and the support material of the present exemplary embodiment is cured to the extent that the droplet D configures a layer LR when irradiated with a total amount of light corresponding to an amount of light of 15 mJ/cm², as an example.

Here, the model material means a material which forms a molded article M that is formed using the forming apparatus 10. In addition, the support material means a material which does not form the molded article M, but forms a three-dimensional object VM along with the model material in a case where the support material is required in a process of forming the molded article M. In the present exemplary embodiment, after the forming apparatus 10 forms a three-dimensional object VM and the three-dimensional object VM is taken out from the forming apparatus 10, the support material is removed from the three-dimensional object VM by an operator.

The first head 22A and the second head 22B have the same configuration except for a material of the droplets D which is ejected therethrough, respectively. As shown in FIG. 2, the first head 22A and the second head 22B are long elements. The first head 22A and the second head 22B are disposed in the order of the first head 22A and the second head 22B from the other side in the apparatus width direction and are fitted in the second through-hole H of the carriage CR from the other side in the apparatus width direction.

As shown in FIG. 1, the first head 22A has a flat surface facing the base plate BD. As shown in FIG. 2, plural nozzles N are formed in the flat surface of the first head 22A to line up at regular intervals in the apparatus depth direction. The plural nozzles N have a pitch (127 μm) corresponding to, for example, 200 npi (200 nozzles per pitch). In addition, the nozzle N is 50 μm in diameter and a droplet amount of the droplet D which is ejected from the first head 22A is 100 pl (picoliter).

As described above, the side surface of the second head 22B in a lateral direction and the side surface of the first head 22A in a lateral direction contact with each other; specifically, all the nozzles N of the second head 22B are disposed to overlap all the nozzles N of the first head 22A in the apparatus width direction, respectively.

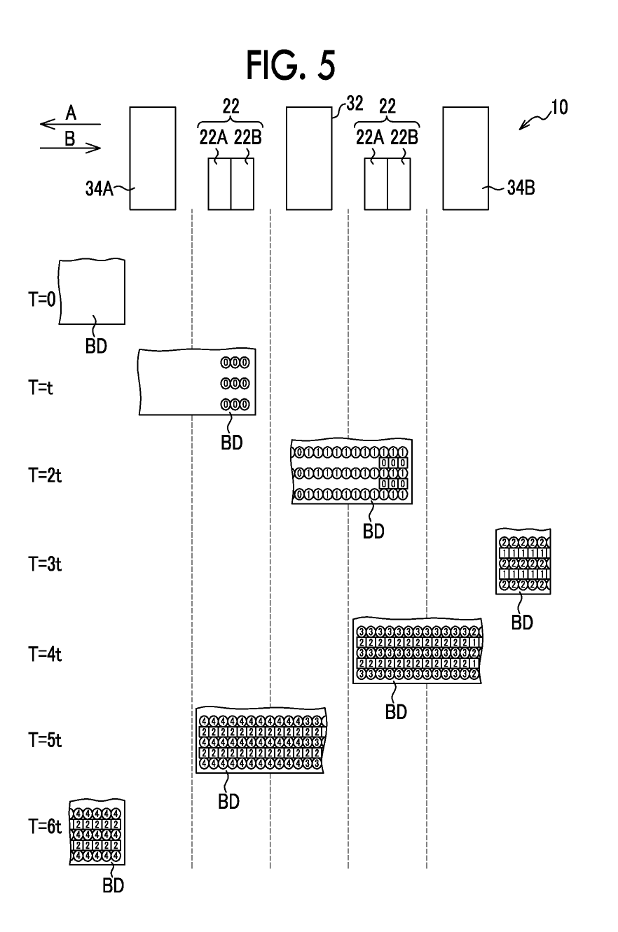

In the configuration described above, when the first ejection unit 22 moves along with the carriage CR in the apparatus width direction and ejects the droplet D toward the base plate BD, the droplets D land in a state of being separated from each other in the apparatus depth direction (refer to FIG. 5). The second head 22B is controlled by the control unit 40 to be described below and ejects the droplet D such that the droplet D is shifted in the apparatus width direction and does not land on the droplet D ejected from the first head 22A.

### Second Ejection Section

The second ejection unit 24 includes a first head 22A and a second head 22B. Similar to the case of the first ejection unit 22, the first head 22A and the second head 22B which configure the second ejection unit 24 are configured to eject a droplet D formed of the model material and a droplet D formed of the support material, respectively.

As shown in FIG. 2, the first head 22A and the second head 22B which configure the second ejection unit 24 are disposed in the order of the first head 22A and the second head 22B from the other side in the apparatus width direction and are fitted in the fourth through-hole H of the carriage CR from the other side in the apparatus width direction. That is, the first ejection unit 22 and the second ejection unit 24 are provided in the carriage CR to be spaced apart with respect to the movement direction of the carriage CR.

Similar to the case of the first ejection unit 22, the first head 22A and the second head 22B which configure the second ejection unit 24 are disposed, in which all the nozzles N of the second head 22B overlap all the nozzles N of the first head 22A in the apparatus width direction, respectively.

The second ejection unit 24 is disposed to be shifted by half pitch (that is, 63.5 μm) in the apparatus depth direction with respect to the first ejection unit 22.

In the configuration described above, the second ejection unit 24 moves along with the carriage CR in the apparatus width direction and ejects the droplet D between the droplets D ejected by the first ejection unit 22 (refer to FIG. 5). Similar to the case of the first ejection unit 22, in the case of the second ejection unit 24, the second head 22B is controlled by the control unit 40 to be described below and ejects the droplet D such that the droplet D is shifted in the apparatus width direction and does not land on the droplet D ejected from the first head 22A. In this manner, one layer is formed to have resolution of a pitch (63.5 μm) corresponding to 400 dpi (400 dots per inch).

### Irradiation Unit

The irradiation unit 30 has a function of irradiating the droplet D with light (ultraviolet rays as an example) while moving along with the carriage CR with respect to the base plate BD in the apparatus width direction and of curing the droplet D. As shown in FIG. 1 and FIG. 2, the irradiation unit 30 includes a first irradiation unit 32 and a second irradiation unit 34.

### First Irradiation Unit

As shown in FIG. 2, the first irradiation unit 32 is a long element. The first irradiation unit 32 is fitted in the third through-hole H of the carriage CR from the other side in the apparatus width direction in a state in which the longitudinal direction of the first irradiation unit 32 is in the apparatus depth direction. Here, a region surrounded in a dotted line in the first irradiation unit 32 in FIG. 2 indicates a light emission region of the first irradiation unit 32. A separated distance from the emission region to the plural nozzles N of the first head 22A of the first ejection unit 22 in the apparatus width direction is equal to a separated distance from the emission region to the plural nozzles N of the second head 22B of the second ejection unit 24 in the apparatus width direction. A separated distance from the emission region to the plural nozzles N of the first head 22B of the first ejection unit 22 in the apparatus width direction is equal to a separated distance from the emission region to the plural nozzles N of the second head 22A of the second ejection unit 24 in the apparatus width direction. In other words, in the present exemplary embodiment, the first irradiation unit 32 is disposed at the center between the first ejection unit 22 and the second ejection unit 24 in the carriage CR. The first irradiation unit 32 of the present exemplary embodiment is set to perform irradiation with an amount of light of 15 mJ/cm².

### Second Irradiation Unit

As shown in FIG. 2, the second irradiation unit 34 is configured to have a pair of the second irradiation units 34A and 34B. The second irradiation units 34A and 34B of the present exemplary embodiment are configured similar to the first irradiation unit 32. The pair of second irradiation units 34A and 34B are fitted in the first and fifth through-holes H from the other side of the apparatus width direction in the carriage CR in a state in which the longitudinal directions of the irradiation units are parallel to the apparatus depth direction. In other words, the pair of second irradiation units 34A and 34B are provided in the carriage CR with the first ejection unit 22 and the second ejection unit 24 interposed therebetween. Here, a region surrounded in a dotted line in the second irradiation unit 34A in FIG. 2 indicates a light emission region of the second irradiation unit 34A. A separated distance from the emission region to the plural nozzles N of the first head 22A of the first ejection unit 22 in the apparatus width direction is equal to a separated distance from the emission region of the first irradiation unit 32 to the plural nozzles N of the second head 22B of the first ejection unit 22 in the apparatus width direction. In other words, according to the present exemplary embodiment, a separated distance from the first ejection unit 22 to the second irradiation unit 34A is equal to a separated distance from the first ejection unit 22 to the first irradiation unit 32 in the apparatus width direction. In addition, a separated distance from the second ejection unit 24 to the second irradiation unit 34B is equal to a separated distance from the second ejection unit 24 to the first irradiation unit 32. The second irradiation units 34A and 34B of the present exemplary embodiment is set to perform irradiation with an amount of light of 15 mJ/cm². In other words, in the present exemplary embodiment, an amount of light with which all the irradiation units which perform irradiation and configure the irradiation unit 30, is equally set.

### Control Unit

The control unit 40 has a function of controlling the respective units except a control unit 40 which configures the forming apparatus 10. Specifically, the control unit 40 controls the respective units except the control unit 40 in response to data received from an external apparatus (not illustrated). Hereinafter, a relationship between ejection control of the ejection section 20, irradiation control of the irradiation unit 30, and a movement control of the carriage CR by the control unit 40 will be described. When the control unit 40 receives the data from the external apparatus, data of the three-dimensional object VM contained in the data is converted into layer data for forming the layers LR obtained by slicing the three-dimensional object VM with a predetermined thickness on a sectional plane perpendicular to the height direction. The control unit 40 controls the respective units except the control unit 40, which configure the forming apparatus 10, in response to the layer data.

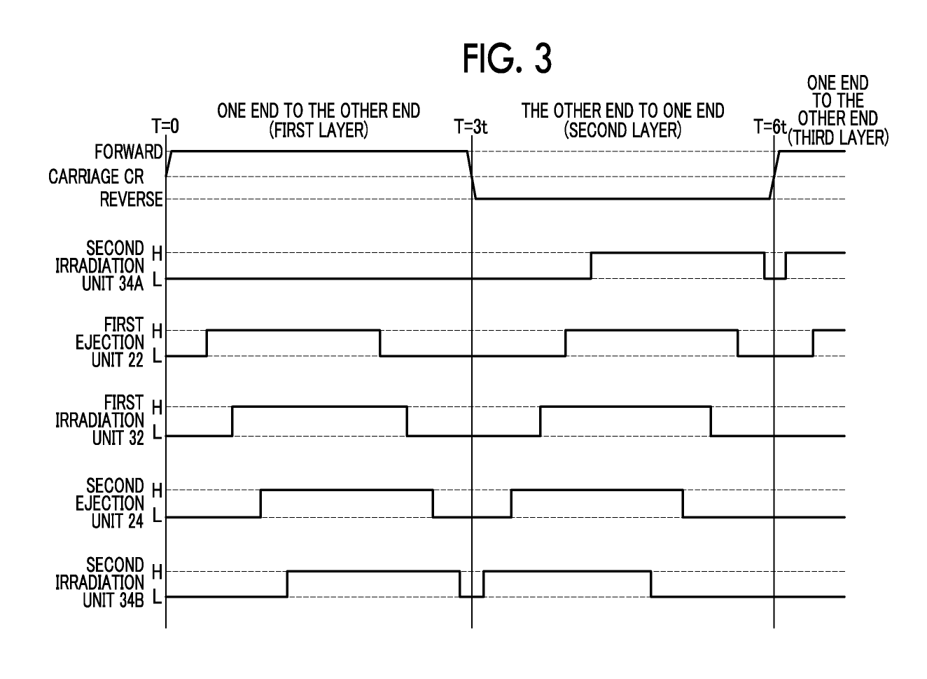

In a case where the carriage CR moves from one end side to the other end side (hereinafter, referred to as a forward direction, with arrow A in the drawings indicating the forward direction) in the apparatus width direction, the first ejection unit 22 corresponds to an ejection section on the downstream side in the movement direction of the carriage CR and the second ejection unit 24 corresponds to an ejection section on the upstream side in the movement direction of the carriage CR. In the case where the control unit 40 causes the carriage CR to move in the forward direction, the ejection section 20 which is controlled by the control unit 40 causes the first ejection unit 22 to eject the droplets D (first droplets D1) toward the base plate BD in response to the layer data. In addition, after the ejection section 20 causes the first ejection unit 22 to eject the first droplets D1, the second ejection unit 24 is caused to eject the droplet D (second droplet D2) between the first droplets D1. The case where the carriage CR moves in the forward direction corresponds to an operation (operation from time T of 0 to 3t in FIG. 3 to FIG. 6) by the control unit 40 from the start (at the time of start, time T is 0) of movement of the carriage CR until time T passes 3t.

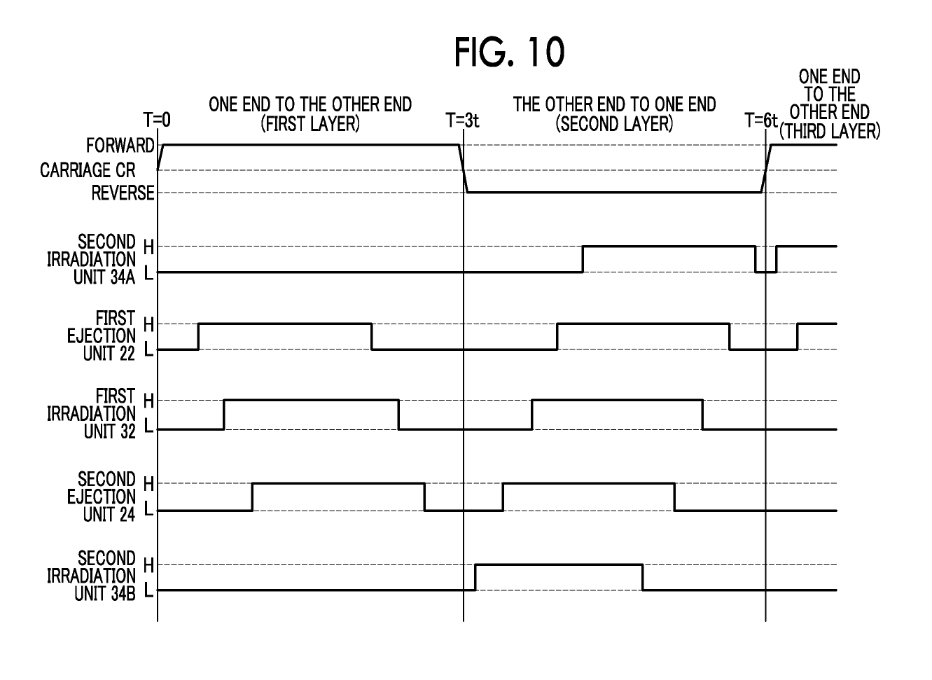

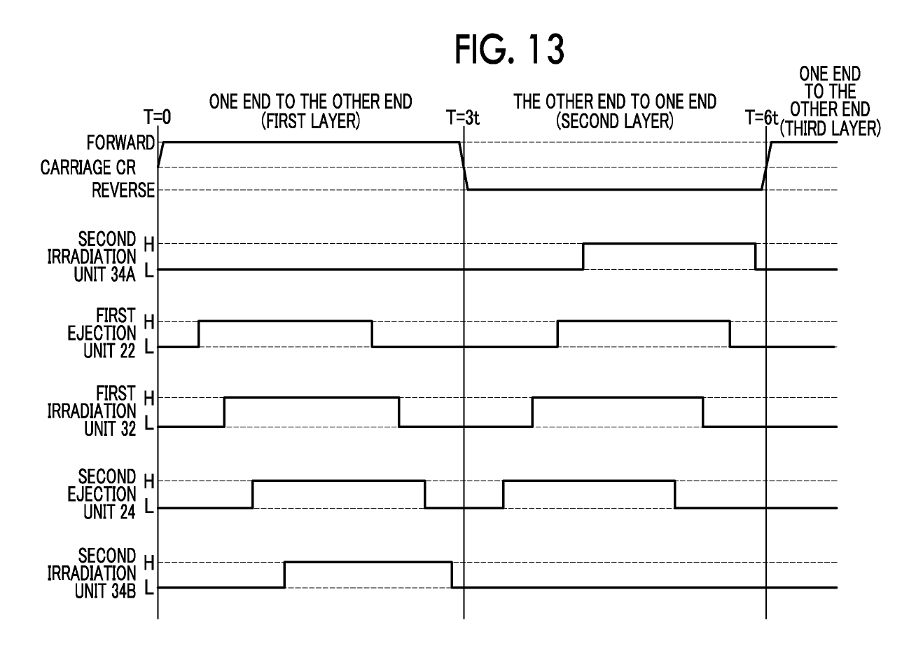

Here, in FIG. 3, in a case of the carriage CR, “forward” indicates a state in which the carriage CR is driven to move in the forward direction and “reverse” indicates a state in which the carriage CR is driven to move in the reverse direction. In addition, in a case of the first ejection unit 22 and the second ejection unit 24, “L” indicates a state in which the first ejection unit 22 and the second ejection unit 24 do not perform an ejection operation and “H” indicates a state in which the first ejection unit 22 and the second ejection unit 24 perform an ejection operation or prepare the operation. Further, in a case of the first irradiation unit 32 and the second irradiation units 34A and 34B, “L” indicates a state in which irradiation with light is not performed and “H” indicates a state in which irradiation with light is performed. The same is true for FIG. 10 and FIG. 13 to be described below.

In addition, as described above, the first irradiation unit 32 is provided between the first ejection unit 22 and the second ejection unit 24 in the carriage CR. The first irradiation unit 32 controlled by the control unit 40 irradiates the first droplet D1 ejected from the first ejection unit 22, with light, before the second droplet D2 is ejected from the second ejection unit 24, and causes the first droplet D1 to be cured.

In addition, as described above, the second irradiation unit 34B is provided on the one end side of the carriage CR in the apparatus width direction. In other words, in a case where the carriage CR moves in the forward direction, the second irradiation unit 34B corresponds to an irradiation unit on the upstream side in the movement direction of the carriage CR. In a case where the control unit 40 causes the carriage CR to move in the forward direction, the second irradiation unit 34B controlled by the control unit 40 irradiates the second droplet D2 ejected from the second ejection unit 24 with light and causes the second droplet D2 to be cured.

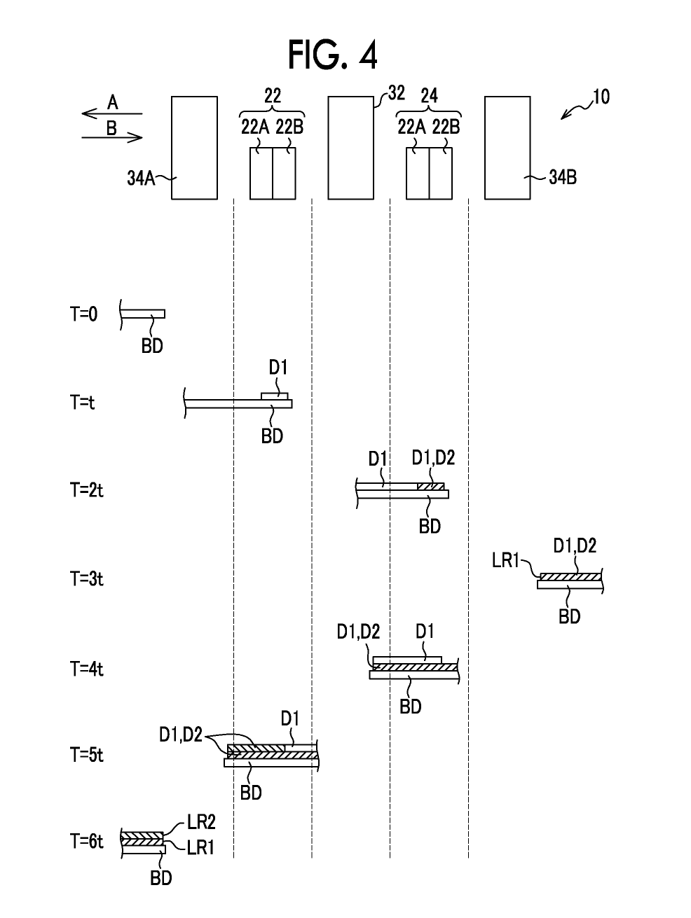

As described above, the control unit 40 controls the respective units and causes the carriage CR to move in the forward direction with respect to the base plate BD and to form layers LR (odd-numbered layers LR from the lower side, for example, the layer LR1 in FIG. 1 and FIG. 4) formed by curing the first droplet D1 and the second droplet D2.

In a case where the carriage CR moves from the other end side to the one end side (hereinafter, referred to as a reverse direction, with arrow B in the drawings indicating the reverse direction) in the apparatus width direction, the second ejection unit 24 corresponds to an ejection section on the downstream side in the movement direction of the carriage CR and the first ejection unit 22 corresponds to an ejection section on the upstream side in the movement direction of the carriage CR. In this case, the ejection section 20 which is controlled by the control unit 40 causes the second ejection unit 24 to eject the droplet D (first droplet D1) in response to the layer data and then, causes the first ejection unit 22 to eject the droplet D (second droplet D2) between the first droplets Dl. The first irradiation unit 32 controlled by the control unit 40 irradiates the first droplet D1 ejected from the second ejection unit 24, with light, before the second droplet D2 is ejected from the first ejection unit 22, and causes the first droplet D1 to be cured. The second irradiation unit 34A which is provided on the other end side of the carriage CR in the apparatus width direction is controlled by the control unit 40 and irradiates the second droplet D2 ejected from the first ejection unit 22 with light and causes the second droplet D2 to be cured. The case where the carriage CR moves in the reverse direction corresponds to an operation (operation from time T of 3t to 6t in FIG. 3 to FIG. 6) by the control unit 40 from the start (at the time of start, time T is 0) of the movement of the carriage CR in the reverse direction until time T passes 3t.

As described above, the control unit 40 controls the respective units and causes the carriage CR to move in the reverse direction with respect to the base plate BD and to form layers LR (even-numbered layers LR from the lower side, for example, the layer LR2 in FIG. 1 and FIG. 4) formed by curing the first droplet D1 and the second droplet D2.

The forming apparatus 10 of the present exemplary embodiment forms a three-dimensional object VM through stacking layers LR by control of operations of the respective units by the control unit 40.

The first droplet D1 means the droplet D which is ejected from the ejection unit on the downstream side in the movement direction of the carriage CR with respect to the base plate BD and the second droplet D2 means the droplet D which is ejected from the ejection unit on the upstream side in the movement direction, of the first ejection unit 22 and the second ejection unit 24 which configure the ejection section 20.

As above, the configuration of the forming apparatus 10 of the present exemplary embodiment is described.

### Forming Method of Molded Article

Subsequently, a forming method of the molded article M using the forming apparatus 10 of the present exemplary embodiment will be described with reference to FIG. 3 to FIG. 6.

### Conversion of Data

First, when the control unit 40 receives data from the external apparatus, the control unit 40 converts the data of three-dimensional object VM contained in the data into layer data for forming the layers LR.

### Forming of First Layer

Subsequently, the control unit 40 causes the carriage CR, which is disposed at the home position, to move in the forward direction by the drive source and causes the first ejection unit 22 to eject the first droplet D1. Subsequently, the control unit 40 causes the first irradiation unit 32 to irradiate the first droplet D1 with light along with the movement of the carriage CR in the forward direction. As a result, the first droplet D1 is irradiated with light and is cured. Subsequently, the control unit 40 causes the second ejection unit 24 to eject the second droplet D2 between the first droplets D1 along with the movement of the carriage CR in the forward direction. Subsequently, the control unit 40 causes the second irradiation unit 34B to irradiate the second droplet D2 with light along with the movement of the carriage CR in the forward direction. As a result, the second droplet D2 is irradiated with light and is cured. In addition, the first droplet D1 is irradiated also with the light with which the second irradiation unit 34B performs irradiation. When the control unit 40 causes the carriage CR to move to the end on the other end in the apparatus width direction, a layer LR (refer to the layer LR1 in FIG. 1 and the FIG. 4) formed by curing the first droplet D1 and the second droplet D2 is formed on the base plate BD. The control unit 40 causes the carriage CR to move to the end on the other end side in the apparatus width direction and then, further, causes the carriage CR to move to the upper side in the apparatus height direction by the thickness of the layer LR.

### Forming of Second and Subsequent Layers

When the second and the following layers LR are formed, the operation of forming the first layer LR is repeated by reversing the movement direction of the carriage CR. When the control unit 40 causes the respective units except the control unit 40 to form the three-dimensional object VM through stacking all the layers LR, the control unit 40 causes the carriage CR to move to home position and the forming operation of the three-dimensional object VM using the forming apparatus 10 of the present exemplary embodiment ends. After the forming operation of the three-dimensional object VM using the forming apparatus 10 ends and the three-dimensional object VM. is taken out from the forming apparatus 10 by an operator, the cured support material is removed from the three-dimensional object VM and the molded article M is formed.

As above, the forming method of the molded article M of the present exemplary embodiment is described.

### Effects

Subsequently, the effects of the present exemplary embodiment (first and second effects) will be described with reference to the drawings.

### First Effect

The first effect of the forming apparatus 10 of the present exemplary embodiment will be described in comparison to a forming apparatus 10A of a first comparative exemplary embodiment to be described below. In the following description, in a case where the same component as in the forming apparatus 10 of the present exemplary embodiment is used in the forming apparatus 10A of the first comparative exemplary embodiment, the same reference signs are attached to the same components.

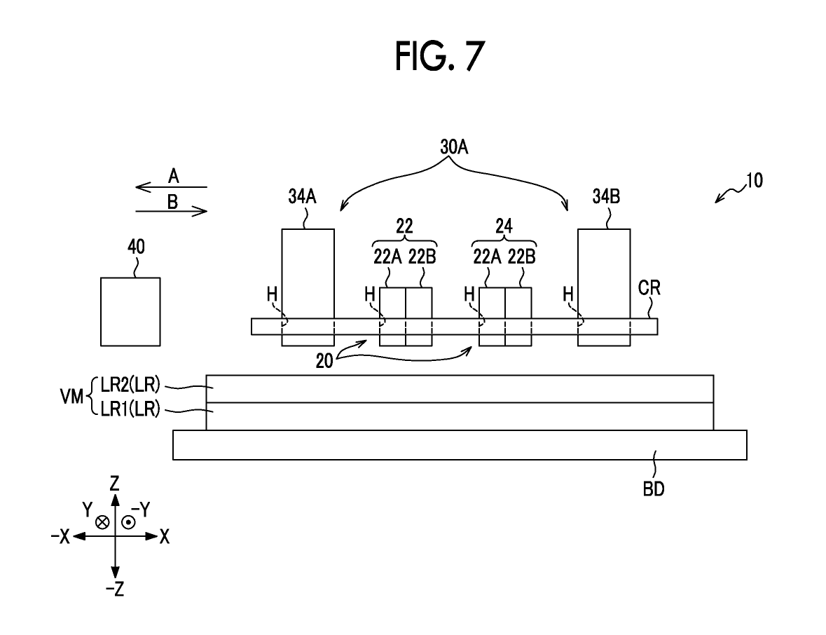

As shown in FIG. 7, the first irradiation unit 32 is not provided in the forming apparatus 10A of the first comparative exemplary embodiment. Except for that, the forming apparatus 10A of the first comparative exemplary embodiment has the same configuration as the forming apparatus 10 of the present exemplary embodiment.

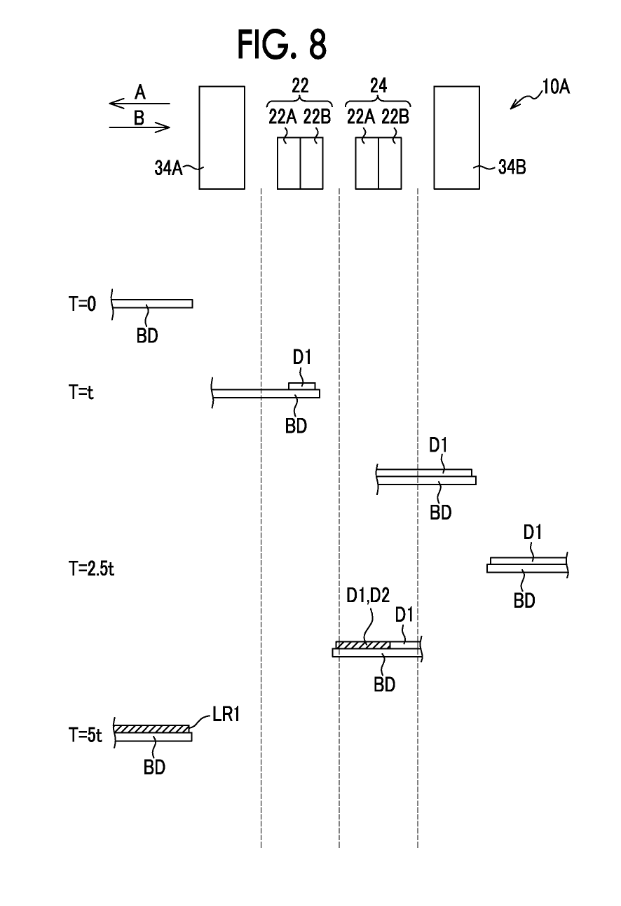

In addition, the forming method of the molded article M used in the forming apparatus 10A of the first comparative exemplary embodiment (hereinafter, referred to as the forming method of the first comparative exemplary embodiment) is performed as follows. In other words, the control unit 40 causes the carriage CR to move in the forward direction, the first ejection unit 22 to eject the first droplet D1, and, further, the second irradiation unit 34B on the downstream side in the forward direction to irradiate the first droplet D1 with light and to cure the first droplet D1 (refer to the operation from the time T of 0 to 2.5t in FIG. 8). Subsequently, the control unit 40 causes the carriage CR to move in the reverse direction, the second ejection unit 24 to eject the second droplet D2, and, further, the second irradiation unit 34A on the downstream side in the reverse direction to irradiate the second droplet D2 with light and to cure the second droplet D2 (refer to the operation from the time T of 2.5t to 5t in FIG. 8). As described above, in the case of the forming apparatus 10A of the first comparative exemplary embodiment, when the carriage CR reciprocates, one layer LR having a resolution corresponding to 400 dpi, which is formed of the cured first and second droplets D1 and D2 is formed. From a different perspective, in the forming apparatus 10A of the first comparative exemplary embodiment, it is not possible to form one layer LR configured of the first droplet D1 and the second droplet D2 which are cured, whenever the carriage CR reciprocating with respect to the base plate BD moves in one direction (one direction of the forward direction or the reverse direction) of the carriage CR. Except for that, the forming method of the molded article M of the first comparative exemplary embodiment is the same as the forming method of the molded article M of the present exemplary embodiment.

By comparison, as described above, the forming apparatus 10 of the present exemplary embodiment includes the first irradiation unit 32 between the first ejection unit 22 and the second ejection unit 24 in the carriage CR (refer to FIG. 1 and FIG. 2). In addition, in the forming apparatus 10 of the present exemplary embodiment, the carriage CR is caused to move in the forward direction, the first ejection unit 22 is caused to eject first droplet D1, the first irradiation unit 32 is caused to irradiate the first droplet D1 with light, and then, the second ejection unit 24 is caused to eject the second droplet D2 between the first droplets Dl. After that, in the forming apparatus 10 of the present exemplary embodiment, the second droplet D2 is irradiated with light using the second irradiation unit 34B and the second droplet D2 is cured.

Therefore, according to the forming apparatus 10 of the present exemplary embodiment, it is possible to form one layer LR configured of the first droplet D1 and the second droplet D2 which are cured, whenever the carriage CR reciprocating with respect to the base plate BD moves in one direction. From a different perspective, according to the forming apparatus 10 (forming method of the molded article M) of the present exemplary embodiment, it is possible to form the three-dimensional object VM with the same accuracy and to shorten the forming time of the three-dimensional object VM in comparison to the forming apparatus (method) in which the first droplet D1 is ejected and cured along with the movement of the carriage CR in one direction and the second droplet D2 is ejected and cured along with the movement in the other direction.

In the forming apparatus 10A of the first comparative exemplary embodiment, while the carriage CR is caused to move in the forward direction, using the first ejection unit 22 and the second ejection unit 24 on which nozzles N are arranged at a pitch of 100 npi, the first ejection unit 22 is caused to eject the first droplet D1, further, the second ejection unit 24 is caused to eject the second droplet D2, and the second irradiation unit 34B is caused to irradiate and cure the first droplet D1 and the second droplet D2 with light. In this case, it is not possible to form one layer LR configured of the first droplet D1 and the second droplet D2 which are cured, along with the movement of the carriage CR reciprocating with respect to the base plate BD in one direction (one direction of the forward direction or the reverse direction). By comparison, according to the forming apparatus 10 (forming method of the molded article M) of the present exemplary embodiment, it is possible to form the three-dimensional object VM with the same accuracy and to shorten the forming time of the three-dimensional object VM.

In addition, in the forming apparatus 10A of the first comparative exemplary embodiment, while the carriage CR is caused to move in the forward direction, using the first ejection unit 22 and the second ejection unit 24 on which the nozzles N are arranged at a pitch of 200 npi, the first ejection unit 22 is caused to eject the first droplet D1, further, the second ejection unit 24 is caused to eject the second droplet D2, and the second irradiation unit 34B is caused to irradiate and cure the first droplet D1 and the second droplet D2 with light. In this case, the droplet D corresponding to one layer is ejected along with the movement in one direction. However, since the first irradiation unit 32 is not provided, a phenomenon such as moving and joining of the first droplet D1 and the second droplet D2 with each other, which results in deterioration of the accuracy of the three-dimensional object VM. By comparison, according to the forming apparatus 10 (forming method of the molded article M) of the present exemplary embodiment, it is possible to suppress the first droplet D1 and the second droplet D2 not to move and join each other and to form one layer LR along with the movement of the carriage CR in one direction.

### Second Effect

The second effect of the forming apparatus 10 of the present exemplary embodiment will be described in comparison to a forming apparatus 10B of a first comparative exemplary embodiment to be described below. In the following description, in a case where the same component as in the forming apparatus 10 of the present exemplary embodiment is used in the forming apparatus (not illustrated) of the second comparative exemplary embodiment, the same reference signs are attached to the same components.

The first irradiation unit 32 of the forming apparatus of the second comparative exemplary embodiment is disposed to be closer to one of the first ejection unit 22 or the second ejection unit 24 in the carriage CR. A separated distance between the first ejection unit 22 and the second ejection unit 24 in the apparatus width direction is equal to that in the present exemplary embodiment. Except for that, the forming apparatus of the second comparative exemplary embodiment has the same configuration as the forming apparatus 10 of the present exemplary embodiment. In addition, the forming method of the molded article M of the second comparative exemplary embodiment is the same as the forming method of the molded article M of the present exemplary embodiment except that the forming apparatus of the second comparative exemplary embodiment is used instead of the forming apparatus 10 of the present exemplary embodiment. The second comparative exemplary embodiment is included in a technical scope of the exemplary embodiment of the invention. The second comparative exemplary embodiment achieves the first effects described above.

When the three-dimensional object VM is formed using the forming apparatus of the second comparative exemplary embodiment, there is a concern that the light with which the first irradiation unit 32 irradiates the droplet D will be reflected and will reach the nozzles N of the first ejection unit 22 and the nozzles N of the second ejection unit 24. In the case of the forming apparatus of the second comparative exemplary embodiment, an amount of the light reaching the nozzles N on the ejection section which has a short distance from the first irradiation unit 32 is greater than an amount of light reaching the nozzles N of the other ejection section. Thus, there is a concern that the nozzles N receiving greater amount of light is likely to be clogged and the ejection section has to be often replaced.

By comparison, in the case of the forming apparatus 10 of the present exemplary embodiment, the first irradiation unit 32 is disposed at the center between the first ejection unit 22 and the second ejection unit 24 in the carriage CR (refer to FIG. 1 and FIG. 2).

Therefore, according to the forming apparatus 10 of the present exemplary embodiment, it is possible to have an equal amount of reflected light reaching the first ejection unit 22 and the second ejection unit 24 after the irradiation is performed from the first irradiation unit 32 and thus, the replacement of the ejection section due to clogging of the nozzles N is performed as frequently as the forming apparatus in which the first irradiation unit 32 is disposed to be closer to one or the first ejection unit 22 and the second ejection unit 24. In this manner, in the forming apparatus 10 of the present exemplary embodiment, in a case where the first ejection unit 22 and the second ejection unit 24 are disposed at positions where are not influenced by the light from the first irradiation unit 32 and where the first ejection unit 22 and the second ejection unit 24 are positioned to be closest to the first irradiation unit 32, it is possible to decrease a distance between the ejection section 20 and the first irradiation unit 32 of the carriage CR in the apparatus width direction, in comparison to the forming apparatus described above. In other words, the forming apparatus 10 of the present exemplary embodiment decreases the forming time along with the miniaturization of the carriage CR and the forming apparatus 10 itself is decreased in size along with the miniaturization of the carriage CR.

### Second Exemplary Embodiment

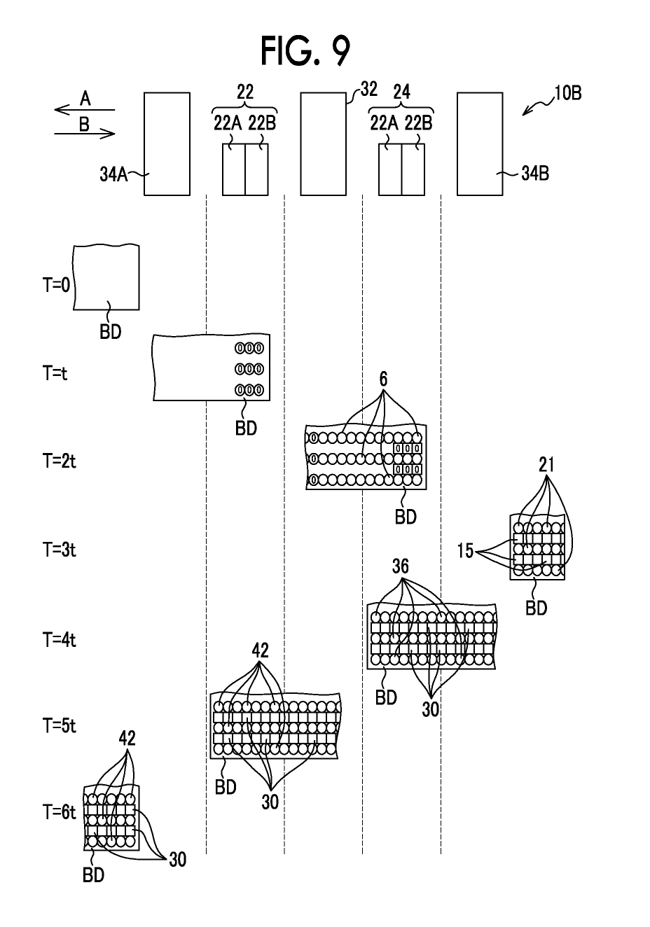

Next, a forming apparatus 10B of the second exemplary embodiment will be described with reference to FIG. 9. In the following description, a configuration of the forming apparatus 10B of the present exemplary embodiment and a forming method of a molded article M using the forming apparatus 10B of the present exemplary embodiment, and effects of the present exemplary embodiment will be described in this order. In the following description, in a case where the same component as in the forming apparatus 10 of the first exemplary embodiment is used in the forming apparatus 10B of the present exemplary embodiment, the same reference signs are attached to the same components.

### Configuration

In the case of the forming apparatus 10B of the present exemplary embodiment, the first irradiation unit 32 is set to perform irradiation with an amount of light of, as an example, 6 mJ/cm². In other words, the first irradiation unit 32 of the forming apparatus 10B of the present exemplary embodiment performs irradiation with an amount of light smaller than the light with which the second irradiation units 34A and 34B perform irradiation. Except for that, the forming apparatus 10B of the present exemplary embodiment has the same configuration as the forming apparatus 10 of the first exemplary embodiment.

### Forming Method of Molded Article

The forming method of the molded article M of the present exemplary embodiment is the same as the forming method of the molded article M of the first exemplary embodiment except that the forming apparatus 10B of the present exemplary embodiment is used instead of the forming apparatus 10 of the first exemplary embodiment. In other words, the control unit 40 of the present exemplary embodiment controls the respective elements in accordance with a timing chart of the first exemplary embodiment shown in FIG. 3.

### Effects

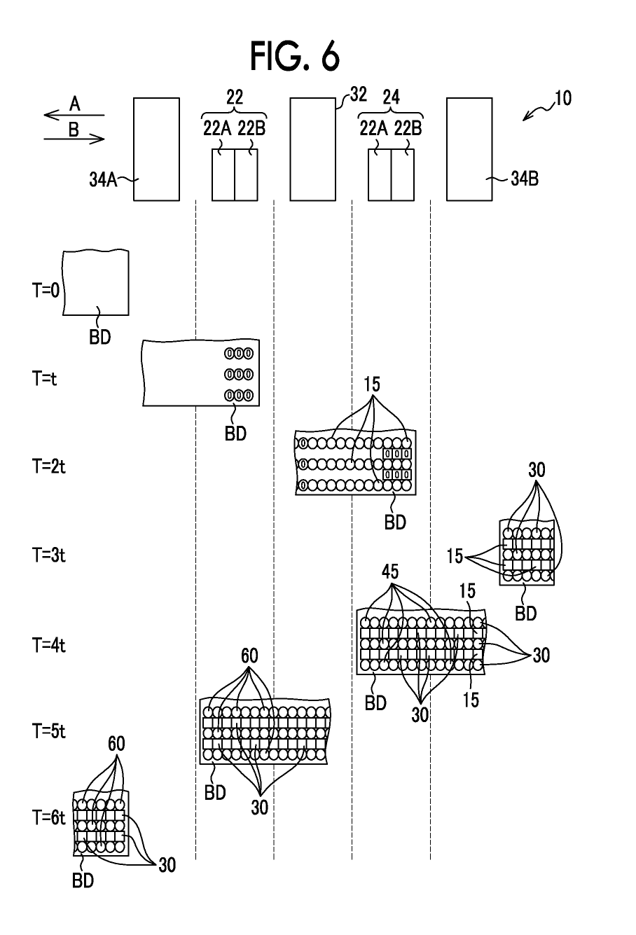

In the case of the first exemplary embodiment, the first irradiation unit 32 is set to perform irradiation with the amount of light of 15 mJ/cm². In the case of the first exemplary embodiment, as shown in FIG. 6, the carriage CR is caused to reciprocate, the first droplet D1 of the layer LR1 is irradiated with a total amount of light of 60 mJ/cm² (the total amount of light is not increased because a droplet of the second layer is formed thereon when the time T of 5t elapses) and the second droplet D2 of the layer LR1 is irradiated with a total amount of light of 30 mJ/cm² (the total amount of light is not increased because a droplet of the second layer is formed thereon when the time T of 4t elapses), at a time point (time point of the time T of 6t in FIG. 6) of stacking two layers LR.

By comparison, in the case of the present exemplary embodiment, the first irradiation unit 32 is set to perform irradiation with the amount of light of 6 mJ/cm². In the case of the present exemplary embodiment, as shown in FIG. 9, the carriage CR is caused to reciprocate, the first droplet D1 of the layer LR1 is irradiated with a total amount of light of 42 mJ/cm² and the second droplet D2 of the layer LR1 is irradiated with a total amount of light of 30 mJ/cm², at a time point (time point of the time T of 6t in FIG. 9) of stacking the two layers LR.

Therefore, according to the forming apparatus 10B of the present exemplary embodiment, it is possible to decrease a difference between total amounts of light with which a portion configured of the cured first droplet D1 and a portion configured of the cured second droplet D2, of the layer LR, are irradiated, in comparison to the forming apparatus in which the first irradiation unit 32 and the second irradiation units 34A and 34B perform the irradiation with the same amount of light. As the difference between the total amounts of light, with which the two portions which configure the same layer LR are irradiated, is smaller, the layer LR is formed with higher accuracy. Thus, according to the forming apparatus 10B of the present exemplary embodiment, it is possible to form the three-dimensional object VM with high accuracy in comparison to the forming apparatus in which the second irradiation units 34A and 34B always perform the irradiation with the same amount of light.

According to the forming apparatus 10B of the present exemplary embodiment, it is possible to form the three-dimensional object VM with the same accuracy and to save power consumption of the first irradiation unit 32 in comparison to the forming apparatus in which the first irradiation unit 32 and the second irradiation units 34A and 34B perform the irradiation with the same amount of light. The other effects of the present exemplary embodiment are the same as those of the first exemplary embodiment.

In the case of the forming apparatus 10B of the present exemplary embodiment, as described above, the first irradiation unit 32 performs the irradiation with an amount of light smaller than that of the light with which the second irradiation units 34A and 34B perform irradiation; however, the control unit 40 may control amounts of light with which the first irradiation unit 32 and the second irradiation units 34A and 34B perform the irradiation.

### Third Exemplary Embodiment

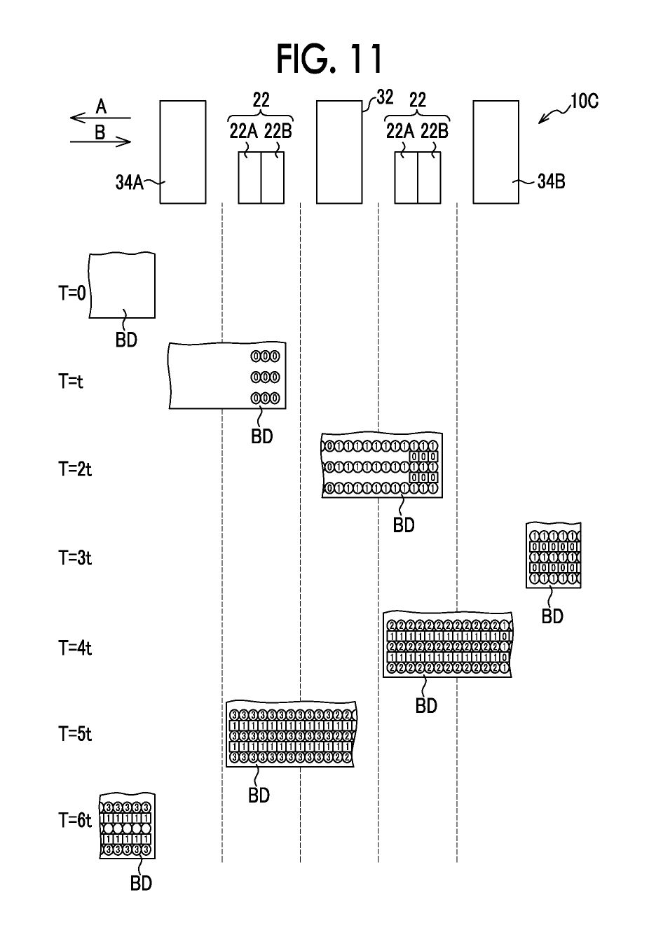

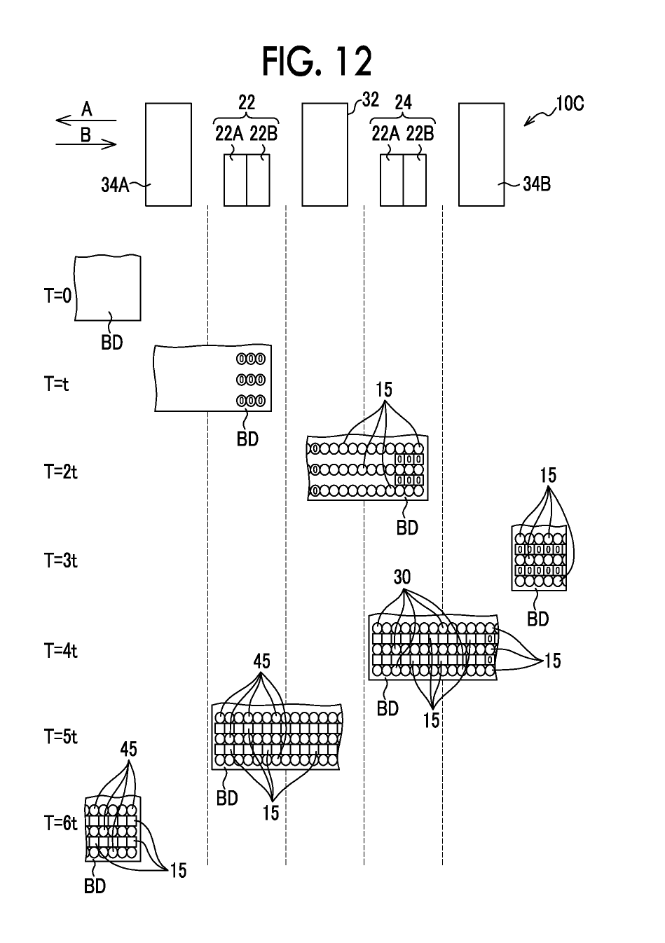

Next, a forming apparatus 10C of the third exemplary embodiment will be described with reference to FIG. 10 to FIG. 12. In the following description, a configuration of the forming apparatus 10C of the present exemplary embodiment and a forming method of a molded article M using the forming apparatus 10C of the present exemplary embodiment, and effects of the present exemplary embodiment will be described in this order.

Configuration and Forming Method of Molded article

In the case of the present exemplary embodiment, the control unit 40 causes the second irradiation unit 34 on the downstream side in the movement direction of the carriage CR not to perform irradiation with light along with the movement of the carriage CR. Specifically, as shown in FIG. 10, the control unit 40 causes the second irradiation unit 34B (34A) not to perform the irradiation with light along with the movement of the carriage CR in the forward (reverse) direction, and causes the second irradiation unit 34A (34B) to perform the irradiation with light along with the movement of the carriage CR in the reverse (forward) direction. Thus, in the case of the present exemplary embodiment, the second droplet D2 ejected from the second ejection unit 24 (first ejection unit 22) is irradiated and cured with light by the second irradiation unit 34B (34A) along with the movement of the carriage CR in the reverse (forward) direction, in a process in which the carriage CR is reversed and moves in the reverse (forward) direction. Except for that, the forming apparatus 10C of the present exemplary embodiment has the same configuration as the forming apparatus 10 of the first exemplary embodiment. The forming method of the molded article M of the present exemplary embodiment is the same as the forming method of the molded article M of the first exemplary embodiment except that the forming apparatus 10C of the present exemplary embodiment is used instead of the forming apparatus 10 of the first exemplary embodiment.

### Effects

The effects of the present exemplary embodiment are the same as the first exemplary embodiment. In the case of the present exemplary embodiment, the second droplet D2 of the layer LR is irradiated with a total amount of light of 15 mJ/cm², which is smaller than that in the case of the first exemplary embodiment (refer to FIG. 6) and that in the case of the second exemplary embodiment (refer to FIG. 9). Thus, the present exemplary embodiment is effective in a case where the droplet D containing a material which is likely to be cured is used.

### Fourth Exemplary Embodiment

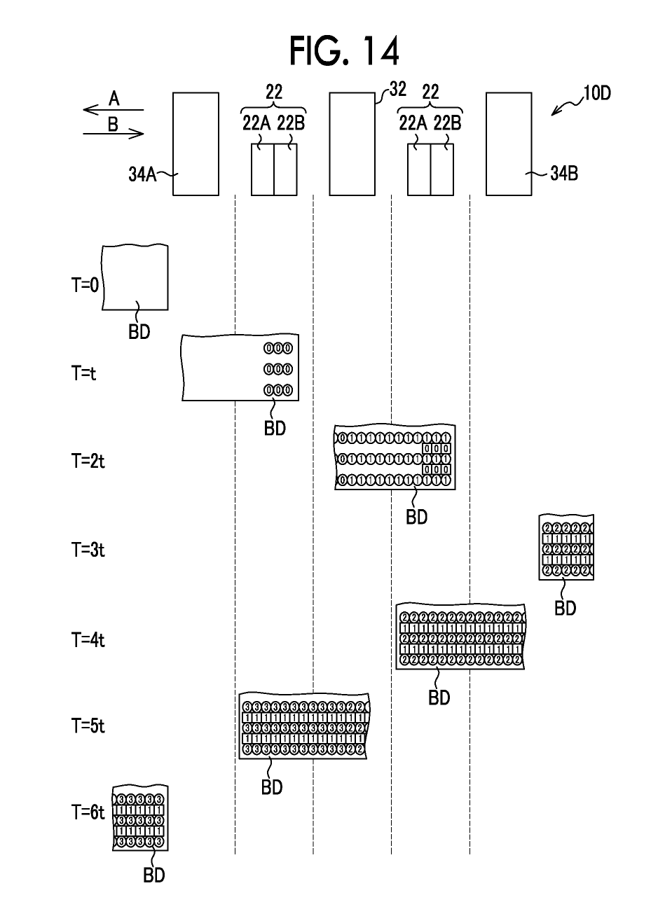

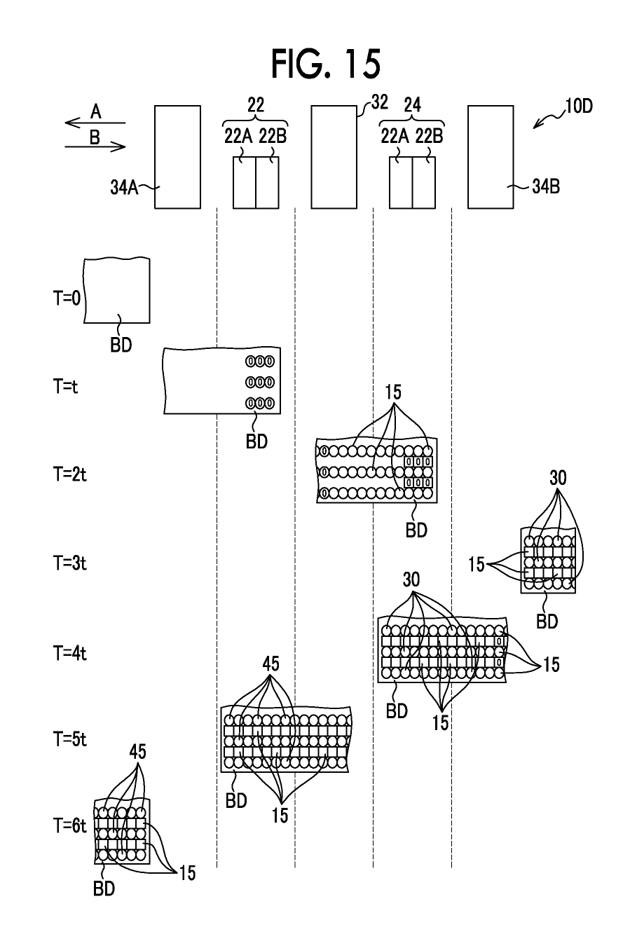

Next, a forming apparatus 10D of the fourth exemplary embodiment will be described with reference to FIG. 13 to FIG. 15. In the following description, a configuration of the forming apparatus 10D of the present exemplary embodiment and a forming method of a molded article M using the forming apparatus 10D of the present exemplary embodiment, and effects of the present exemplary embodiment will be described in this order.

### Configuration and Forming Method of Molded Article

In the case of the present exemplary embodiment, the control unit 40 causes the second irradiation unit 34 on the upstream side in the movement direction of the carriage CR not to perform irradiation with light along with the movement of the carriage CR. Specifically, as shown in FIG. 13, the control unit 40 causes the second irradiation unit 34B (34A) not to perform the irradiation with light along with the movement of the carriage CR in the reverse (forward) direction. Thus, in the case of the present exemplary embodiment, the layer LR configured of the cured first and second droplets D1 and D2 is not irradiated with light by the second irradiation unit 34B (34A) on the downstream side in the movement direction along with the movement of the carriage CR in the reverse (forward) direction. Except for that, the forming apparatus 10D of the present exemplary embodiment has the same configuration as the forming apparatus 10 of the first exemplary embodiment. In addition, the forming method of the molded article M of the present exemplary embodiment is the same as the forming method of the molded article M of the first exemplary embodiment except that the forming apparatus 10D of the present exemplary embodiment is used instead of the forming apparatus 10 of the first exemplary embodiment.

### Effects

The effects of the present exemplary embodiment are the same as the first and third exemplary embodiments.

### Fifth Exemplary Embodiment

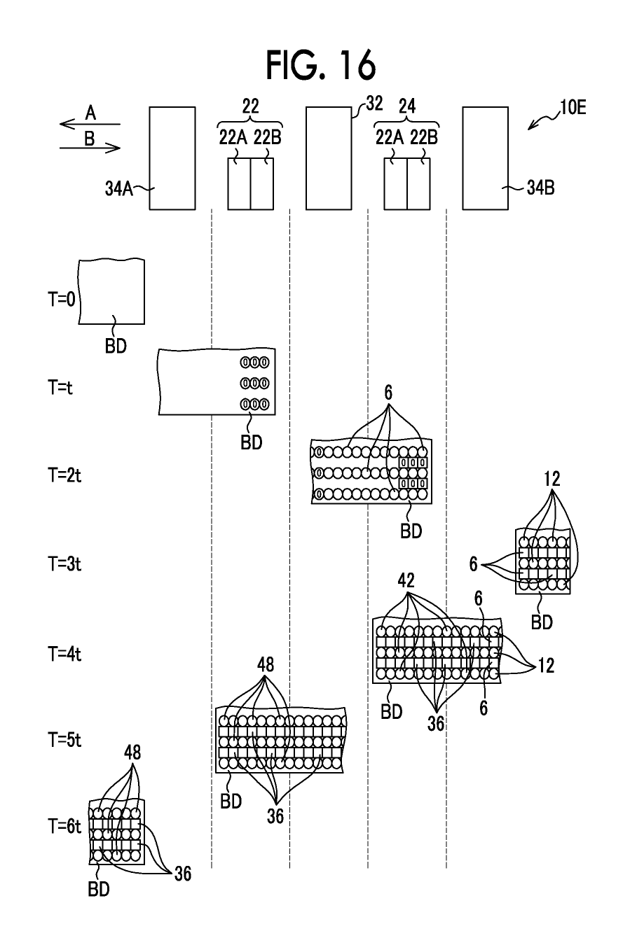

Next, a forming apparatus 10E of the fifth exemplary embodiment will be described with reference to FIG. 16. In the following description, a configuration of the forming apparatus 10E of the present exemplary embodiment and a forming method of a molded article M using the forming apparatus 10E of the present exemplary embodiment, and effects of the present exemplary embodiment will be described in this order.

### Configuration and Forming Method of Molded Article

In the case of the forming apparatus 10E of the present exemplary embodiment, the first irradiation unit 32 is set to perform irradiation with the amount of light of, as an example, 6 mJ/cm². In addition, the second irradiation units 34A and 34B are set to perform irradiation with, by switching between an amount of light of, as an example, 6 mJ/cm² and an amount of light of 30 mJ/cm². Specifically, in a case where the control unit 40 of the forming apparatus 10E of the present exemplary embodiment causes the respective units to form the layer LR, the control unit 40 causes the first irradiation unit 32 and the irradiation unit on the upstream side in the movement direction of the carriage CR of either of the second irradiation units 34 to perform the irradiation with an amount of light of 6 mJ/cm². In a case where the control unit 40 causes the respective units to form the layer LR and then another layer LR is stacked on the layer LR (that is, in a case of moving the carriage CR in a reverse direction to the movement direction of the case of forming the layer LR), the control unit 40 causes the irradiation unit on the downstream side in the reverse direction, of the second irradiation units 34, to perform irradiation with an amount of light of 30 mJ/cm². In other words, in a case where the control unit 40 of the present exemplary embodiment causes the layer LR to be formed and then another layer LR is stacked on the layer LR, the control unit 40 causes the irradiation unit on the downstream side in the reverse direction, of the second irradiation units 34 to perform irradiation with an amount of light greater than the light with which the first and the second irradiation units perform irradiation when the layer LR, on which another layer LR is stacked, is formed. As a main concept of the present exemplary embodiment, regardless of whether the movement direction is the forward direction or the reverse direction, the second irradiation unit 34 on the downstream side in the movement direction immediately after the forward and reverse directions of the movement direction are reversed is caused to perform irradiation with an amount of light greater than the light with which the second irradiation unit 34 performs the irradiation immediately before the direction is reversed. As described above, in the case of the present exemplary embodiment, when the carriage CR is caused to move in the forward direction, the total amount of light with which the first droplet D1 is irradiated is 12 mJ/cm² and the total amount of light with which the second droplet D2 is irradiated is 6 mJ/cm². In the case of the present exemplary embodiment, when the carriage CR is caused to move in the reverse direction, the total amount of light with which the first droplet D1 which configures the layer LR is irradiated is 48 mJ/cm² and the total amount of light with which the second droplet D2 is irradiated is 36 mJ/cm². In other words, in the case of the present exemplary embodiment, when the carriage CR is caused to reciprocate, the total amounts of light with which the first droplet D1 and the second droplet D2 are is irradiated have a difference of 12 mJ/cm² from each other and the layer LR is configured. From a different perspective, in the case of the present exemplary embodiment, the second droplet D2 is irradiated with light plural times, that is, the curing of the second droplet D2 is performed plural times. Here, in the case of the present exemplary embodiment, at the time when the reciprocation of the carriage CR ends, the second layer LR2 is stacked on the first layer LR1. In other words, in the case of the present exemplary embodiment, it is possible to form one layer LR configured of the cured first and the second droplets D1 and D2, whenever the carriage CR which reciprocates with respect to the base plate BD moves in one direction. Except for that, the forming apparatus 10E of the present exemplary embodiment has the same configuration as the forming apparatus 10 of the first exemplary embodiment. The forming method of the molded article M of the present exemplary embodiment is the same as the forming method of the molded article M of the first exemplary embodiment except that the forming apparatus 10E of the present exemplary embodiment is used instead of the forming apparatus 10 of the first exemplary embodiment.

### Effects

In the first exemplary embodiment, in the case of forming the layer LR, the total amount of light with which the first droplet D1 is irradiated is 60 mJ/cm² and the total amount of light with which the second droplet D2 is irradiated is 30 mJ/cm² (refer to FIG. 6). Thus, a difference between the total amounts of light with which two portions (a portion configured of the cured first droplet D1 and a portion configured of the cured second droplet D2) which configure the same layer LR is 30 mJ/cm².

By comparison, as described above, the forming apparatus 10E of the present exemplary embodiment has a configuration in which the control unit 40 switches between the amounts of light with which the second irradiation unit 34 performs the irradiation. Thus, in the present exemplary embodiment, in the case of forming the layer LR, the total amount of light with which the first droplet D1 is irradiated is 48 mJ/cm², the total amount of light with which the second droplet D2 is irradiated is 36 mJ/cm², and the difference between the total amounts of light with which the two portions are irradiated is 12 mJ/cm².

Therefore, according to the forming apparatus 10E of the present exemplary embodiment, it is possible to decrease the difference between the total amounts of light with which the portion configured of the cured first droplet D1 and the portion configured of the cured second droplet D2, of the layer LR, in comparison to the forming apparatus in which the second irradiation units 34A and 34B always perform the irradiation with the same amount of light, that is, in comparison to the forming apparatus in which the irradiation unit on the downstream side in the reverse direction of the second irradiation units 34 is caused to perform the irradiation along with the movement of the carriage CR in the reverse direction to the movement direction with the same amount of light as the light with which the irradiation is performed along with the movement in the movement direction in a case where the layer LR is formed and then, another LR is stacked on the layer LR. Thus, according to the forming apparatus 10E of the present exemplary embodiment, it is possible to form the three-dimensional object VM with high accuracy, in comparison to the forming apparatus in which the second irradiation units 34A and 34B always perform the irradiation with the same amount of light. The effects of the present exemplary embodiment are the same as the first exemplary embodiment.

In addition, in the case of the present exemplary embodiment, as described above, the second droplet D2 is irradiated with light plural times. Thus, in the forming apparatus 10E of the present exemplary embodiment, it is possible to decrease the amount of light with which the second irradiation unit 34A and 34B perform the irradiation.

As described above, specific exemplary embodiments of the invention are described in detail; however, the invention is not limited to the exemplary embodiments described above and other various exemplary embodiments may be provided within the scope of the invention.

For example, in the description of the first exemplary embodiment, the base plate BD is fixed to the forming apparatus 10 and the carriage CR moves relatively to the base plate BD. However, both the base plate BD and the carriage CR may be configured to move relatively to each other. For example, a configuration may be employed, in which the carriage CR is fixed to the main body of the forming apparatus 10 and the base plate BD moves relatively to the carriage CR. In addition, the carriage CR may be configured to reciprocate in the apparatus width direction with respect to the main body of the forming apparatus 10 and the base plate BD may be configured to move relatively to the main body of the forming apparatus 10 in the apparatus height direction. In addition, in a case of forming a three-dimensional object VM. larger than the ejection section 20 in the longitudinal direction, the carriage CR may be configured to move relatively to the base plate BD in the apparatus depth direction. The same is true for the second to fifth exemplary embodiments.

In addition, in the description of the exemplary embodiments, the control unit 40 causes each of the irradiation units 32, 34A, and 34B to perform irradiation with an amount of light of, as an example, 6 mJ/cm², 15 mJ/cm², or 30 mJ/cm². However, the amount of light of 15 mJ/cm², or 30 mJ/cm² is only an example and an amount of light maybe used, which satisfies a condition of each of the exemplary embodiments and which is greater than the amount of light (6 mJ/cm²) with which the droplet D is cured at the extent that a movement from a landing position does not occur even when the droplet D contacts with a droplet D which is not irradiated with light. In the description of the present exemplary embodiment, the amount of light of 6 mJ/cm² is used as an example of an amount of light with which the droplet D is cured to the extent that a movement from a landing position does not occur even when the droplet D contacts with a droplet D which is not irradiated with light. In addition, the amount of light of 15 mJ/cm² is used as an example of an amount of light with which the droplet D is cured to the extent that the droplet D configures the layer LR. However, it is needless to say that the two amounts of light, described above, become different depending on a material that configures the droplet D, a size of the droplet D, or the like.

In addition, in the description of the exemplary embodiments, the amount of light with which the first irradiation unit 32 performs the irradiation is equal to or less than the amount of light with which the second irradiation units 34A and 34B perform the irradiation. However, in the forming apparatus, as long as the second droplet is caused to be ejected along with the movement in the one direction after the first droplet is caused to be ejected and to be cured along with the movement of the moving unit in one direction, the amount of light with which the first irradiation unit 32 performs the irradiation may be greater than the amount of light with which the second irradiation units 34A and 34B perform the irradiation.

In addition, in the description of the exemplary embodiments, the first ejection unit 22 and the second ejection unit 24 include the first head 22A and the second head 22B, respectively, the droplet D configured of a model material is ejected from the first head 22A, and the droplet D configured of the support material is ejected from the second head 22B. However, as described above, the support material configures the three-dimensional object VM with the model material as necessary in a process of forming the molded article M; however, the support material is a material which does not configure the molded article M. In the forming apparatuses 10, 10B, 10C, 10D, and 10E, the second head 22B that configures the first ejection unit 22 and the second ejection unit 24 is not a necessary part.

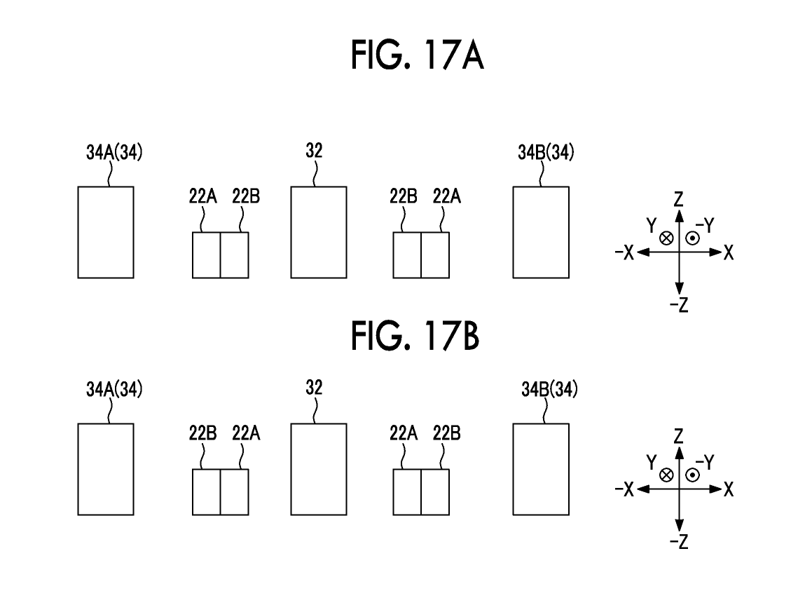

In addition, in the description of the first ejection unit 22 and the second ejection unit 24 of the exemplary embodiments, the first head 22A and the second head 22B line up from the other end side to the one end side in the apparatus width direction (refer to FIG. 1 and FIG. 2). However, the lining up order is only an example and, for example, as shown in FIG. 17A, the second head 22B may be disposed on the first irradiation unit 32 side in each of the ejection units 22 and 24 in the apparatus width direction. In addition, for example, as shown in FIG. 17B, the first head 22A may be disposed on the first irradiation unit 32 side in each of the ejection units 22 and 24 in the apparatus width direction. In comparison to the cases of the exemplary embodiments, the second irradiation units 34A and 34B may be disposed far apart from the first ejection unit 22 and the second ejection unit 24, respectively. In the case described above, the disposition as shown in FIG. 17A and 17B, for example, is effective in a case where the droplet D that is ejected from a head disposed on the side opposite to the first irradiation unit 32 side in the apparatus width direction is easily cured when irradiated with light in comparison to the droplet D which is ejected from a head disposed on the first irradiation unit 32 side.

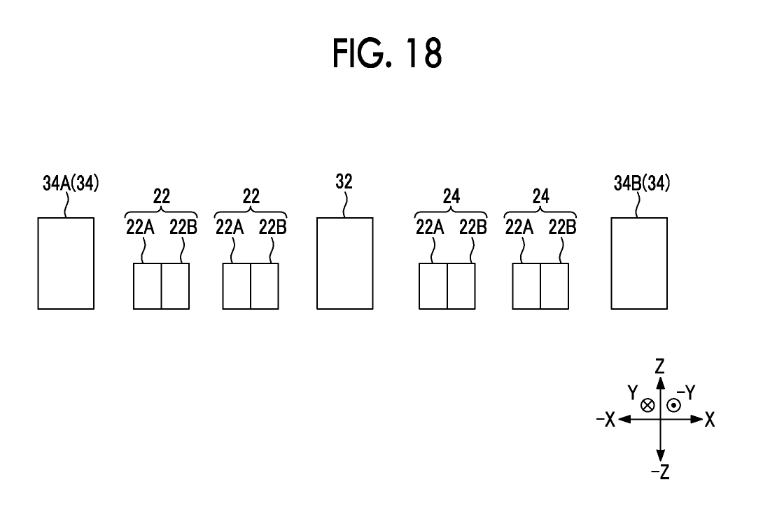

In addition, in the description, the ejection section 20 of the exemplary embodiments is configured to include the first ejection unit 22 and the second ejection unit 24 (refer to FIG. 1 and FIG. 2). In the description, the ejection units 22 and 24 are configured to include the first head 22A and the second head 22B, respectively. However, as shown in FIG. 18, the greater number of the first ejection sections 22 and the second ejection sections 24 may be disposed on both sides in the apparatus width direction with the first irradiation unit 32 interposed therebetween.

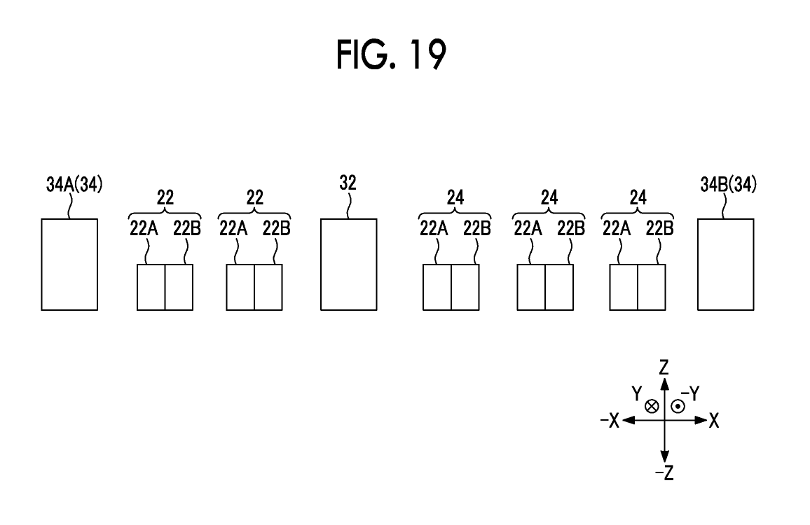

In addition, in the configuration of the exemplary embodiments, one first ejection unit 22 is disposed between the first irradiation unit 32 and the second irradiation unit 34A and one second ejection unit 24 is disposed between the first irradiation unit 32 and the second irradiation unit 34B (refer to FIG. 1 and FIG. 2). In addition, in the configuration of the modification example (FIG. 18) described above, two first ejection sections 22 are disposed between the first irradiation unit 32 and the second irradiation unit 34A and two second ejection sections 24 are disposed between the first irradiation unit 32 and the second irradiation unit 34B. However, as shown in FIG. 19, the number of the first ejection sections 22 disposed between the first irradiation unit 32 and the second irradiation unit 34A may be different from the number of the second ejection sections 24 disposed between the first irradiation unit 32 and the second irradiation unit 34B.

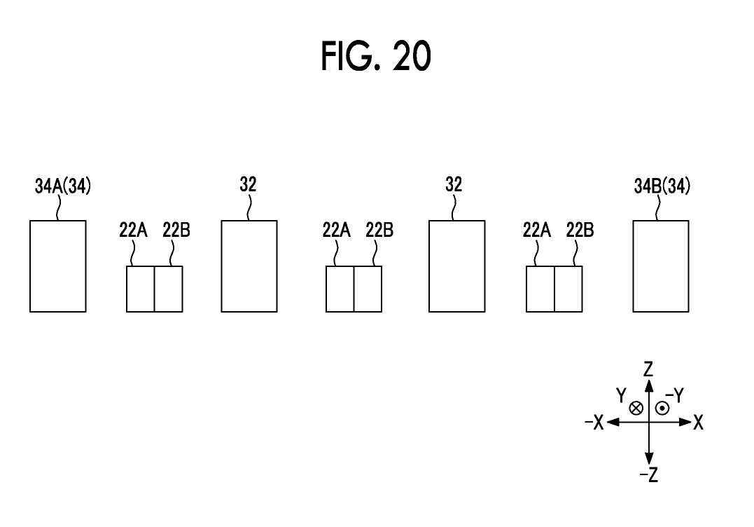

In addition, in the description of the exemplary embodiments, the forming apparatuses 10, 10B, 10C, 10D, and 10E include the first ejection unit 22 and the second ejection unit 24 as the ejection section 20, include the first irradiation unit 32 and the second irradiation units 34A and 34B as the irradiation unit 30, and include the second irradiation unit 34A, the first ejection unit 22, the first irradiation unit 32, the second ejection unit 24, and the second irradiation unit 34B are lined up in the order from the other end side to the one end side in the apparatus width direction (refer to FIG. 1 and FIG. 2). However, as shown in FIG. 20, an exemplary embodiment, in which another ejection unit and another first irradiation unit 32 are provided and the irradiation unit and the ejection unit are lined up in the order from the other end side to the one end side in the apparatus width direction, is included in the technical scope of the invention.

In addition, in the specification, the five exemplary embodiments (first to fifth exemplary embodiments) are described, respectively. Further, as described above, as a modification example of the exemplary embodiments, exemplary embodiments in FIGS. 17A and 17B, FIG. 18, FIG. 19, and FIG. 20 are described. An exemplary embodiment configured of combination of one exemplary embodiment of the exemplary embodiments and the modification examples with the elements in the other exemplary embodiments and the examples is included in the technical scope of the invention. For example, in the forming apparatus 10E of the fifth exemplary embodiment, the amount of light with which the irradiation unit on the downstream side in the movement direction of the carriage CR may not be 6 mJ/cm², but may be 15 mJ/cm² as in the second exemplary embodiment.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A forming apparatus comprising:
a base plate;
a moving unit that reciprocates relatively to the base plate;
an ejection section that includes a plurality of ejection units provided in the moving unit apart from the base plate in a movement direction of the moving unit and that ejects a first droplet toward the base plate from an ejection unit on a downstream side in the movement direction while moving relatively to the base plate and then ejects a second droplet between the first droplets from an ejection unit on an upstream side;
a first irradiation unit that is provided between the plurality of ejection units in the moving unit and irradiates the first droplet with light so that the first droplet is cured before the second droplet is ejected;
a pair of second irradiation units that are provided in the moving unit with interposing the plurality of ejection units in the movement direction and irradiates the first droplet and the second droplet with light so that the first droplet and the second droplet are cured; and
a control unit that controls the moving unit, the ejection unit, and the second irradiation unit while moving the moving unit relatively to the base plate to form a three-dimensional object through stacking layers formed by the cured first and second droplets.

2. The forming apparatus according to claim 1, wherein the control unit causes an irradiation unit on the upstream side in the movement direction, of the second irradiation units, to perform irradiation with light along with a movement of the moving unit in the movement direction when the layer is formed.

3. The forming apparatus according to claim 1, wherein the first irradiation unit performs irradiation with an amount of light smaller than an amount of light with which the second irradiation unit performs irradiation.

4. The forming apparatus according to claim 2, wherein the first irradiation unit performs irradiation with an amount of light smaller than an amount of light with which the second irradiation unit performs irradiation.

5. The forming apparatus according to claim 1, wherein the control unit causes an irradiation unit on the downstream side in a reverse direction, of the second irradiation units, to perform irradiation with light along with a movement of the moving unit in the reverse direction with respect to the movement direction when another layer on the layer is stacked after the layer is formed.

6. The forming apparatus according to claim 2, wherein the control unit causes an irradiation unit on the downstream side in a reverse direction, of the second irradiation units, to perform irradiation with light along with a movement of the moving unit in the reverse direction with respect to the movement direction when another layer on the layer is stacked after the layer is formed.

7. The forming apparatus according to claim 5, wherein the control unit causes an irradiation unit on the downstream side in the reverse direction, of the second irradiation units, to perform irradiation with an amount of light along with a movement of the moving unit in the reverse direction with respect to the movement direction, which is greater than an amount of light with which irradiation is performed along with a movement of the moving unit in the movement direction, when another layer on the layer is stacked after the layer is formed.

8. The forming apparatus according to claim 6, wherein the control unit causes an irradiation unit on the downstream side in the reverse direction, of the second irradiation units, to perform irradiation with an amount of light along with a movement of the moving unit in the reverse direction with respect to the movement direction, which is greater than an amount of light with which irradiation is performed along with a movement of the moving unit in the movement direction, when another layer on the layer is stacked after the layer is formed.

9. The forming apparatus according to claim 1, wherein the first irradiation unit is disposed at the center in the plurality of ejection units.

10. The forming apparatus according to claim 2, wherein the first irradiation unit is disposed at the center in the plurality of ejection units.

11. The forming apparatus according to claim 3, wherein the first irradiation unit is disposed at the center in the plurality of ejection units.

12. The forming apparatus according to claim 4, wherein the first irradiation unit is disposed at the center in the plurality of ejection units.

13. The forming apparatus according to claim 5, wherein the first irradiation unit is disposed at the center in the plurality of ejection units.

14. The forming apparatus according to claim 6, wherein the first irradiation unit is disposed at the center in the plurality of ejection units.

15. The forming apparatus according to claim 7, wherein the first irradiation unit is disposed at the center in the plurality of ejection units.

16. The forming apparatus according to claim 8, wherein the first irradiation unit is disposed at the center in the plurality of ejection units.

17. A forming method of a molded article comprising:
ejecting a first droplet toward a base plate from an ejection unit on a downstream side in a movement direction while the ejection unit moves relatively to the base plate, using an ejection section including a plurality of ejection units provided in a moving unit apart from the base plate in a movement direction of the moving unit that reciprocates relatively to the base plate;
irradiating and curing the first droplet with light by an irradiation unit that performs irradiation with light, along with the movement of the moving unit in the movement direction;
ejecting a second droplet between the first droplets from the ejection unit on an upstream side in the movement direction along with the movement of the moving unit in the movement direction;
irradiating and curing the second droplet with light by an irradiation unit that performs irradiation with light; and
repeating the above steps by reversing the movement direction to form a three-dimensional object through stacking layers formed by curing the first and second droplets, by the moving unit, the ejection section, and the irradiation unit.
